(19) United States
(12) Patent Application Publication
(10) Pub. No.: US 2005/0118488 A1
(43) Pub. Date: Jun. 2, 2005

(54) Separator for fuel cell and fuel cell therewith

(75) Inventors: Atsushi Sadamoto, Kawasaki-shi (JP); Norihiro Tomimatsu, Kawasaki-shi (JP); Yasuhiro Harada, Isehara-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/953,270

(22) Filed: Sep. 30, 2004

(30) Foreign Application Priority Data
Sep. 30, 2003 (JP) P2003-341860

(51) Int. Cl. H01M 8/02; H01M 8/10; H01M 8/24

(52) U.S. Cl. 429/38; 429/32

(57) ABSTRACT

A separator for a fuel cell is provided with a separator plate including a first main face and second main face which has countered the first main face and first side face and second side face which has countered the first side face; a first inflow port formed on the first main face at a side of the first side face; plural first outflow ports formed on the first main face at a side of the second side face: plural first flow paths formed on the first main face, the first flow paths serpentinely linking the first inflow port with the first outflow ports; a second inflow port formed on the second main face at a side of the second side face; plural second outflow ports formed on the second main face at a side of the first side face; and plural second flow paths formed on the second main face, the second flow paths serpentinely linking the second inflow port with the second outflow ports.

### CROSS-REFERENCE TO RELATED APPLICATIONS

This application is based upon and claims the benefit of priority from the prior Japanese Patent Application No. 2003-341860 (filed Sep. 30, 2003); the entire contents of which are incorporated herein by reference.

### BACKGROUND OF THE INVENTION

1. Field of the Invention

The present invention relates to a separator and a fuel cell provided with the separator and, more particularly, relates to a separator which can supply fuel to the fuel cell in uniform distribution in view of concentration and temperature and a fuel cell provided therewith so as to generate higher electric power.

2. Description of the Related Art

A fuel cell is conventionally provided with a membrane electrode assembly (“MEA” hereinafter), which is provided with a cathode electrode, an anode electrode and a polymer electrolyte membrane put therebetween. In general, two or more sets of the fuel cells are stacked to form a stack structure to increase generating electric power. The stacked fuel cells are further provided with separators for supplying fuel and oxidant such as air to the MEAs. Each of the separators is inserted between the adjacent pair of MEAs.

Each of the separators is provided with a pair of serpentine flow paths symmetrically formed on both main faces thereof, one of which supplies fuel to the one MEA and the other of which supplies oxidant to the other MEA. Each of the flow paths links an inflow port with an outflow port of the separator and meanders throughout the face of the separator so as to supply the fuel or the oxidant to whole faces of the MEAs and hence have relatively long distance. Manifolds for distributing the fuel or the oxidant to the separators, and collecting exhaust gas from the separators are connected to the inflow port or the outflow port of the separators. A related art is disclosed in Japanese Patent Application Laid-open No. H10-199552.

The separators according to the above description have long flow paths, pressure loss of which is necessarily relatively large. As well, the long flow paths raise differences in concentration and temperature of the fuel between inflow ports and outflow ports of the separators. It leads to reduction of the power generation.

### SUMMARY OF THE INVENTION

According to a first aspect of the present invention, a separator for a fuel cell is provided with a separator plate including a first main face and second main face which has countered the first main face and first side face and second side face which has countered the first side face; a first inflow port formed on the first main face at a side of the first side face; plural first outflow ports formed on the first main face at a side of the second side face; plural first flow paths formed on the first main face, the first flow paths serpentinely linking the first inflow port with the first outflow ports: a second inflow port formed on the second main face at a side of the second side face; plural second outflow ports formed on the second main face at a side of the first side face; and plural second flow paths formed on the second main face, the second flow paths serpentinely linking the second inflow port with the second outflow ports.

According to a second aspect of the present invention, a separator for a fuel cell is provided with a separator member including a first main face and a second main face which has countered the first main face and a first side face and a second side face which has countered the first side face; a first flow channel formed on the first main face, the first flow channel to direct a first fluid from the first side face to the second side face and distribute the first fluid into first and second flows serpenting over the first main face excepting peripheral margins of the first main face; and a second flow channel formed on the second main face, the second flow channel to direct a second fluid from the second side face to the first side face and distribute the second fluid in third and fourth flows serpenting over the second main face excepting peripheral margins of the second main face, the third and fourth flows forming line-symmetry.

According to a third aspect of the present invention, a fuel cell is provided with plural membrane electrode assemblies each including a cathode electrode, an anode electrode and an electrolyte membrane put therebetween; and plural separators, each of the separators including: a separator plate including a first main face and second main face which has countered the first main face and first side face and second side face which has countered the first side face; a first inflow port formed on the first main face at a side of the first side face; plural first outflow ports formed on the first main face at a side of the second side face; plural first flow paths formed on the first main face, the first flow paths serpentinely linking the first inflow port with the first outflow ports; a second inflow port formed on the second main face at a side of the second side face; plural second outflow ports formed on the second main face at a side of the first side face; and plural second flow paths formed on the second main face, the second flow paths serpentinely linking the second inflow port with the second outflow ports, wherein the membrane electrode assemblies and the separators are stacked in alternating layers.

### BRIEF DESCRIPTION OF THE DRAWINGS

FIG. 1 is a side view of a fuel cell stack according to an embodiment of the present invention;

FIGS. 2A and 2B are front and rear plan views of a separator according to the embodiment of the present invention;

FIG. 3 is a partial plan view of the separator shown in FIGS. 2A and 2B, in which throttles and the vicinity are magnified;

FIGS. 4A and 4B are front and rear plan views of a separator according to a comparative example:

FIG. 5A is a schematic illustration of distribution of a fuel concentration on the separator according to the embodiment of the present invention, which should be compared with FIG. 5B according to the comparative example; and

FIG. 6A is a schematic illustration of distribution of a temperature on the separator according to the embodiment of the present invention, which should be compared with FIG. 6B according to the comparative example.

### DETAILED DESCRIPTION OF THE INVENTION

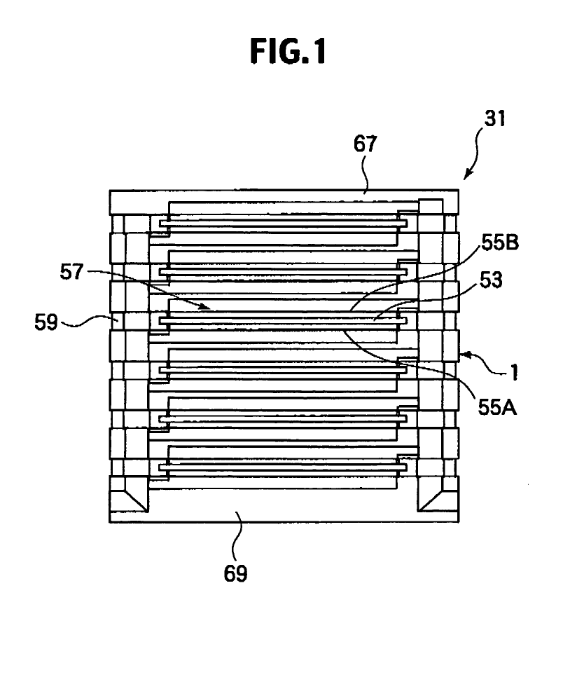

An embodiment of the present invention will be described hereinafter with reference to FIGS. 1 through 3.

A fuel cell stack 31 is provided with plural MEAs 57 each having an anode electrode 55A, a cathode electrode 55B and a polymer electrolyte membrane 53 put therebetween, plural separators 1, plural gaskets 59 surrounding the MEAs 57, an upper end plate 67 and a lower end plate 69 as shown in FIG. 1. The separators 1 and the MEAs 57 are stacked in alternating layers.

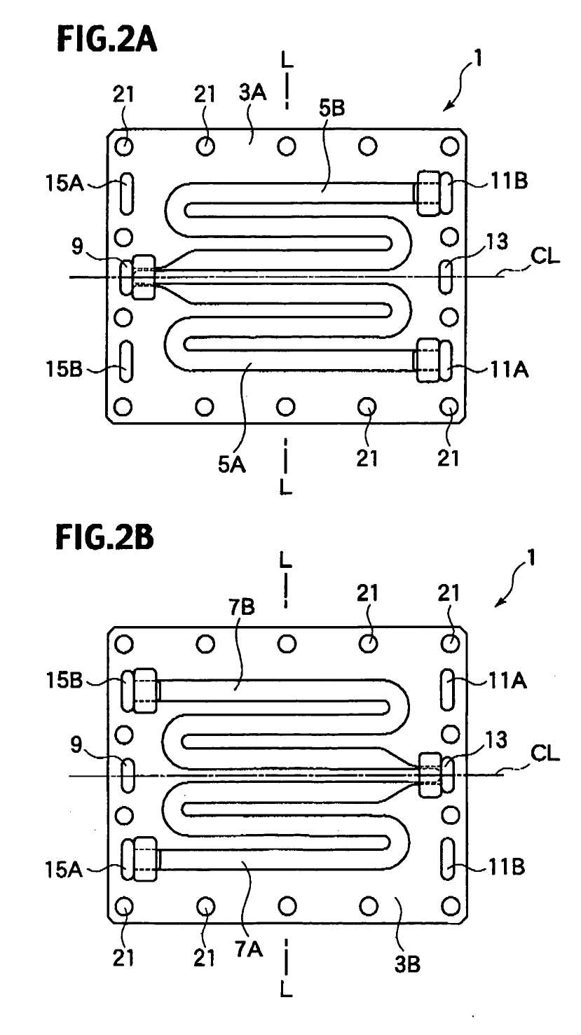

Each of the separators 1 has a first main face 3A shown in FIG. 2A for supplying fuel to an adjacent anode electrode 55A and a second main face 3B shown in FIG. 2B for supplying oxidant to an adjacent cathode 55B. On the first main face 3A, a pair of S-shaped fuel flow channels composed of an inflow port 9, fuel flow paths 5A and 5B and outflow ports 11A and 11B are line-symmetrically formed. As similarly, on the second main face 3B, a pair of S-shaped oxidant flow channels composed of an inflow port 13, oxidant flow paths 7A and 7B and outflow ports 15A and 15B are line-symmetrically formed.

The fuel flow paths 5A and 5B are line-symmetrical with respect to a central line CL drawn laterally substantially central of the separator 1 and likewise the oxidant flow paths 7A and 7B are. The inflow port 9 of the fuel flow paths 5A and 5B is formed on the first main face 3A of the separator 1 and disposed substantially at a lateral center and at a periphery along a first side face thereof. The outflow ports 11A and 11B of the respective fuel flow paths 5A and 5B are formed on the first main face 3A and disposed apart from each other at a periphery along a second side face. As similar with the above, the inflow port 13 of the oxidant flow paths 7A and 7B is formed on the second main face 3B of the separator 1 and disposed substantially at a lateral center and at a periphery along the second side face. The outflow ports 15A and 15B are formed on the second main face 3B and disposed apart from each other at a periphery along the first side face.

In other words, the inflow port 9, the fuel flow paths 5A and 5B and the outflow ports 11A and 11B on the first main face 3A are symmetrical to the inflow port 13, the fuel flow paths 7A and 7B and the outflow ports 15A and 15B on the second main face 3B with respect to the central line L. Furthermore, when the separator 1 rotates 180 degrees with regard to the central line L so as to be turned over, the fuel flow paths 5A and 5B and the outflow ports 11A and 11B substantially and respectively correspond with the inflow port 13, the fuel flow paths 7A and 7B and the outflow ports 15A and 15B.

Widths, depths and lengths of the fuel flow paths 5A and 5B and the oxidant flow paths 7A and 7B are substantially the same with each other. The lengths of the fuel flow paths 5A and 5B and the oxidant flow paths 7A and 7B are reduced by half compared with an comparative example in which each faces of a separator is provided with only one flow path, details of which will be described later. Thereby pressure losses in the flow paths 5A, 5B, 7A and 7B are reduced.

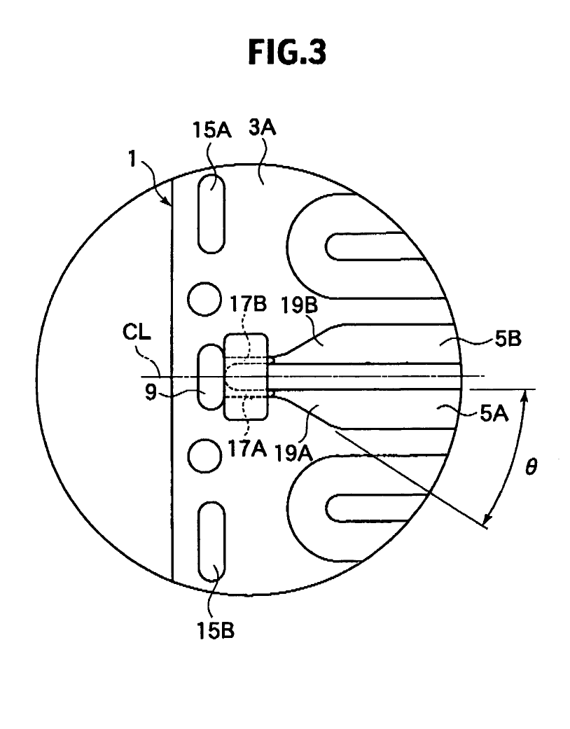

Throttles 17A and 17B in narrow groove shapes are respectively formed between the inflow port 9 and the fuel flow paths 5A and 5B, as shown in FIG. 3, so as to uniformly distribute flows of the fuel into the flow paths 5A and 5B. The throttle 17A and 17B are respectively provided with expanding portions 19A and 19B which respectively link the throttles 17A and 17B with the fuel flow paths 5A and 5B. The expanding portions 19A and 19B gradually expand from the throttle 17A and 17B toward the fuel flow paths 5A and 5B with an expanding angle θ.

The expanding angle θ is preferably between 20 degrees and 45 degrees and more preferably between 25 degrees and 35 degrees. At angles larger than 45 degrees, provided that the fuel flowing into the throttles 17A and/or 17B includes bubbles, the bubbles are uneasy to flow out of the expanding portions 19A and/or 19B and hence may stay there. At angles smaller than 20 degrees, the bubbles rapidly flow out of the expanding portions 19A and/or 19B, however, the expanding portions 19A and 19B must be elongated so as to smoothly connect with the fuel flow paths 5A and 5B and effective areas are reduced.

Walls of the expanding portions 19A and 19B may be formed in various shapes such as straight, concave and convex walls as long as the expanding portions 19A and 19B gradually expand from the throttle 17A and 17B toward the fuel flow paths 5A and 5B.

The inflow port 13 is also provided with throttles and expanding portions and therefore linkage configuration between the inflow port 13 and the oxidant flow paths 7A and 7B is as same as the linkage configuration between the inflow port 9 and the fuel flow paths 5A and 5B. Therefore, further detailed description will be omitted.

The separator 1 is further provided with insertion holes 21, in which fastening means such as tie rods or clamp screws are inserted, at peripheries of the both ends and both sides thereof. The insertion holes 21 are disposed near four corners of the separator 1, intervals between the inflow port 9 and the outflow ports 15A and 15B and intervals between the inflow port 13 and the outflow ports 11A and 11B at substantially even intervals.

Moreover, the insertion holes 21 are line-symmetrical with respect to the central line CL and further to the central line L. Therefore FIG. 2A as the front view of the separator 1 corresponds with FIG. 2B as the rear view thereof when FIG. 2A rotates 180 degrees with respect to the central line CL so as to be turned over.

Therefore the separator 1 can be reversibly used. When the separators 1 are alternately stacked with the MEAs 57 to form the fuel cell stack 31 as shown in FIG. 1, it is unnecessary to care which is the first main face 3A or the second main face 313. Moreover, because the insertion holes 21 are disposed at substantially even intervals, the fuel cell stack 31 can be fastened under a uniform pressure by means of the tie rods or the clamp screws inserted therein.

As described above, the alternately layered separators 1 and MEAs 57 forms the fuel cell stack 31 as shown in FIG. 1. Fuel (methanol aqueous solution for example) supplied to the inflow ports 9 flows through the fuel flow paths 5A and 5B to reach the respective MEAs 57. Air as the oxidant supplied to the inflow ports 13 flows through and the oxidant flow paths 7A and 7B to reach the respective MEAs 57. The fuel reacts with the air at the respective MEAs 57 to generate electric power.

In a case where bubbles exist in the fuel at the expanding portions 19A and 19B in the course of supplying the fuel, the bubbles are prevented from staying at the expanding portions 19A and 19B and easily flow out, Moreover, because the each length of the fuel flow paths 5A and 5B and the oxidant flow paths 7A and 7B is reduced by half compared with a case where each faces of the separator includes only one serpentine flow path meandering throughout the face as mentioned above, the pressure losses in the flow paths 5A, 5B, 7A and 7B are reduced.

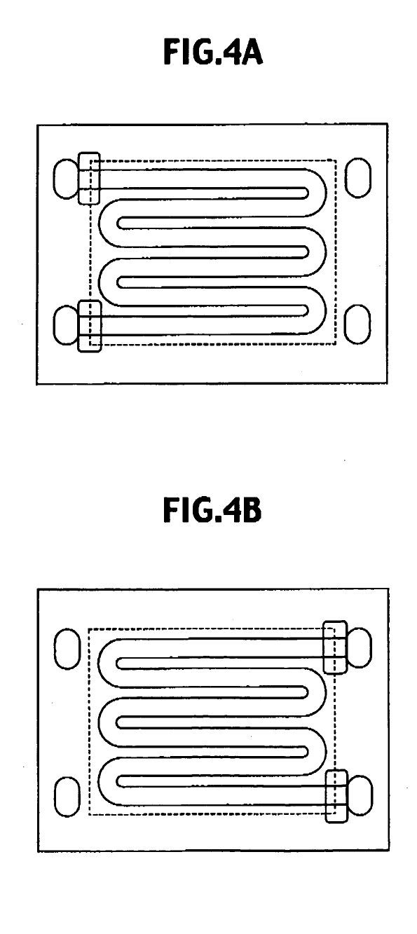

Furthermore, the separator 1 according to the present embodiment of the present invention can supply fuel and air in a uniform temperature and a uniform concentration to MEAs. Uniformity of the temperature and concentration distribution will be described hereinafter with describing a comparison of the present embodiment of the present invention with a comparative example shown in FIGS. 4A and 4B will be described, FIGS. 4A and 4B respectively show both main faces of a separator according to the comparative example. Each of the faces is provided with an inflow port and an outflow port, which are respectively disposed at peripheries along the both side faces, and a serpentine flow path links between the inflow and outflow ports and meanders throughout the face.

A fuel concentration on MEA is on the decrease from an upstream part to a downstream part along the flow path of the separator because the cell reaction consumes the fuel. On the other hand, MEA has a nature of promoting the concentration distribution to be even because of matter diffusion in a porous body thereof. Uniformity of the concentration of the fuel depends on competition of the two phenomena.

According to the present embodiment of the present invention, the upstream part having relatively high concentration of the fuel is disposed at the lateral center of the MEA and the downstream part having relatively low concentration of the fuel is disposed at both sides of the MEA. Thereby diffusion length of the fuel on the MEA is relatively shortened as well as the distribution of the concentration is formed in a symmetrical manner as schematically illustrated in FIG. 5A. In a case of the comparative example, diffusion of the fuel must be achieved from one side thereof where the upstream part is disposed to the other side where the downstream part is disposed as indicated by an arrow in FIG. 5B. As being understood from the comparison between the drawings, the present embodiment of the present invention can give a uniform concentration distribution.

The MEA is heated by the fuel cell reaction and the MEA per se conducts heat toward peripheries thereof and radiates the heat therefrom. Therefore the temperature at a center thereof tends to be relatively higher. The fuel supplied to the MEA functions as a cooling medium and hence removes the heat from the MEA. The fuel flows through the flow paths with removing heat from the MEA and is hence on the increase from the upstream part to the downstream part in the MEA. Therefore the fuel removes the larger amount of heat at an upstream part than at a downstream part along the flow path. Superposition of these phenomena determines the temperature distribution of the MEA.

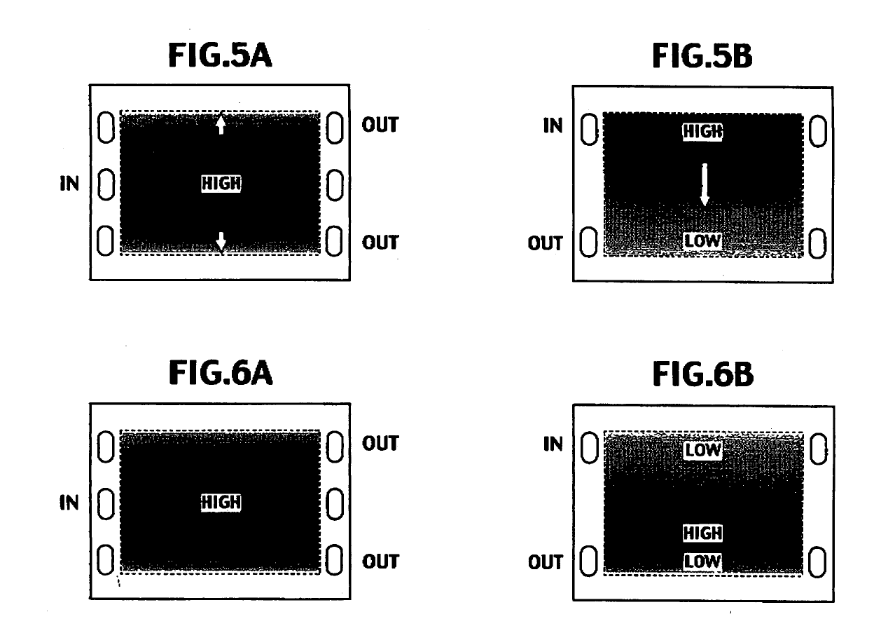

According to the present embodiment of the present invention, the upstream part is disposed at a lateral center of the MEA where the temperature tends to be higher. The inflowing fuel removes and transports the heat from the center to the both sides and the heat conduction by the MEA per se coordinates therewith. Therefore the temperature distribution is promoted to be uniform. Furthermore, the flow paths on the both main faces are symmetrically disposed, thereby the inflowing fluids respectively and effectively exchange heat with the outflowing fluids. Therefore the temperature distribution is further promoted to be uniform and a uniform temperature distribution can be obtained as schematically illustrated in FIG. 6A. In a case of the comparative example, removing heat from the MEA is larger at one side (drawn in an upper half of FIG. 6B) and therefore the temperature distribution is biased as shown in FIG. 6B. As being understood from the comparison between the drawings, the present embodiment of the present invention can give a uniform temperature distribution.

As being understood from the above description, according to the embodiment of the present invention, uniform distribution of the fuel and the air in view of concentration and temperature can be achieved so that increase of the power generation of the fuel cell can be obtained.

Although the invention has been described above by reference to certain embodiments of the invention, the invention is not limited to the embodiments described above. Modifications and variations of the embodiments described above will occur to those skilled in the art, in light of the above teachings.

1. A separator for a fuel cell, comprising:
a separator plate including a first main face and second main face which has countered the first main face and first side face and second side face which has countered the first side face;
a first inflow port formed on the first main face at a side of the first side face;
plural first outflow ports formed on the first main face at a side of the second side face:
plural first flow paths formed on the first main face, the first flow paths serpentinely linking the first inflow port with the first outflow ports;
a second inflow port formed on the second main face at a side of the second side face;
plural second outflow ports formed on the second main face at a side of the first side face; and
plural second flow paths formed on the second main face, the second flow paths serpentinely linking the second inflow port with the second outflow ports.

2. The separator of claim 1, wherein:
the first outflow ports, the first flow paths, the second flow paths and the second flow ports are arranged in pairs, respectively.

3. The separator of claim 2, wherein:
the first and second flow paths are respectively disposed line-symmetrically with respect to a first central line extending from the first side face to the second side face.

4. The separator of claim 1, wherein:
the first and second inflow ports are disposed substantially on a first central line extending from the first side face to the second side face of the separator plate.

5. The separator of claim 1, wherein;
the first flow port, the first flow paths and the first outflow ports are substantially rotationally symmetrical to the second flow port, the second flow paths and the second outflow ports with respect to a second central line parallel to the first and second side faces of the separator plate.

6. The separator of claim 1, wherein;
the first and second flow paths respectively make at least two turns so as to serpent over the first and second main faces excepting peripheral margins of the first and second main faces.

7. The separator of claim 1, further comprising:
first throttles respectively linking the first inflow port with the first flow paths; and
second throttles respectively linking the second inflow port with the second flow paths, each of the first and second throttles including an expanding portion expanding from the throttle toward the flow path.

8. The separator of claim 7, wherein:
each of the expanding portions has an expanding angle from 20 degrees through 45 degrees.

9. A separator for a fuel cell, comprising;
a separator member including a first main face and a second main face which has countered the first main face and a first side face and a second side face which has countered the first side face:
a first flow channel formed on the first main face, the first flow channel to direct a first fluid from the first side face to the second side face and distribute the first fluid into first and second flows serpenting over the first main face excepting peripheral margins of the first main face; and
a second flow channel formed on the second main face, the second flow channel to direct a second fluid from the second side face to the first side face and distribute the second fluid in third and fourth flows serpenting over the second main face excepting peripheral margins of the second main face, the third and fourth flows forming line-symmetry.

10. The separator of claim 9, wherein:
the first flow channel and the second flow channel respectively and substantially form line-symmetry with respect to a first central line extending from the first side face to the second side face of the separator member,

11. The separator of claim 9, wherein:
the first flow channel is substantially rotationally symmetrical to the second flow channel with respect to a second central line parallel to the first and second side faces of the separator member.

12. The separator of claim 9, wherein:
each of the first and second flow channels comprises throttles, each of the throttles including an expanding portion expanding from an upstream part toward a downstream part.

13. The separator of claim 12, wherein:
each of the expanding portions has an expanding angle from 20 degrees through 45 degrees.

14. A fuel cell comprising;
plural membrane electrode assemblies each including a cathode electrode, an anode electrode and an electrolyte membrane put therebetween; and
plural separators, each of the separators including;
a separator plate including a first main face and second main face which has countered the first main face and first side face and second side face which has countered the first side face;
a first inflow port formed on the first main face at a side of the first side face;
plural first outflow ports formed on the first main face at a side of the second side face;
plural first flow paths formed on the first main face, the first flow paths serpentinely linking the first inflow port with the first outflow ports;
a second inflow port formed on the second main face at a side of the second side face;
plural second outflow ports formed on the second main face at a side of the first side face; and
plural second flow paths formed on the second main face, the second flow paths serpentinely linking the second inflow port with the second outflow ports,
wherein the membrane electrode assemblies and the separators are stacked in alternating layers.

15. The fuel cell of claim 14, comprising:
the first outflow ports, the first flow paths, the second flow paths and the second flow ports are arranged in pairs, respectively.

16. The fuel cell of claim 15, wherein;
the first and second flow paths are respectively disposed in line-symmetry.

17. The fuel cell of claim 14, wherein:
the first and second inflow ports are disposed substantially on a first central line extending from the first side face to the second side face of the separator plate.

18. The fuel cell of claim 14, wherein;
the first flow port, the first flow paths and the first outflow ports are substantially rotationally symmetrical to the second flow port, the second flow paths and the second outflow ports with respect to a laterally central line parallel to the first and second side faces of the separator plate.

19. The fuel cell of claim 14, wherein:
the first and second flow paths respectively make at least two turns so as to meander over the first and second main faces excepting peripheral margins of the first and second main faces.

20. The fuel cell of claim 14, further comprising:
first throttles respectively linking the first inflow port with the first flow paths; and
second throttles respectively linking the second inflow port with the second flow paths,
each of the first and second throttles including an expanding portion expanding from the throttle toward the flow path.

21. The fuel cell of claim 18, wherein:
each of the expanding portions has an expanding angle from 20 degrees through 45 degrees.
